(19) United States
(12) Patent Application Publication
(10) Pub. No.: US 2014/0261386 A1
(43) Pub. Date: Sep. 18, 2014

(54) BROIL BURNER OF A HOUSEHOLD COOKING APPLIANCE

(71) Applicant: BSH HOME APPLIANCES CORPORATION, Irvine, CA (US)

(72) Inventors: William Bringe, Powell, TN (US); John Freeman, Knoxville, TN (US); Samuel Harward, Knoxville, TN (US); Rob Ladner, Dryden, MI (US)

(73) Assignee: BSH Home Appliances Corporation, Irvine, CA (US)

(21) Appl. No.: 13/845,316

(22) Filed: Mar. 18, 2013

(51) Int. Cl. A47J 37/06

(52) U.S. Cl. CPC A47J 37/0682
USPC 126/41 R

(57) ABSTRACT

A broil burner and a household cooking appliance having a broil burner are provided in which the household appliance includes a housing having an oven cavity and a broil burner in the oven cavity, wherein the broil burner includes a combustion surface with a plurality of ports for permitting a gas/air mixture to permeate through the combustion surface, wherein an area of the plurality of the ports is blocked or plugged to prevent the gas/air mixture from permeating through the combustion surface in the area.

### FIELD OF THE INVENTION

The present invention is directed to a broil cooking unit of a household appliance, and more particularly, an improved broil burner of a household cooking appliance having a combustion surface with a plurality of blocked or plugged ports.

### BACKGROUND OF THE INVENTION

Household cooking appliances commonly include one or more broil burners in an oven cavity for cooking food. Manufacturers of household cooking appliances are always working to improve the evenness with which appliances broil food. Conventional household cooking appliances may include one or more different types of broil burners. For example, an appliance commonly may include two smaller broil burners that are side by side but have a space separating them, while another appliance may include a single, large broil burner that covers a majority of the top of the oven cavity.

### SUMMARY OF THE INVENTION

The present invention, as illustrated for example in the exemplary embodiments, provides a broil burner for a household cooking appliance, the broil burner comprising a combustion surface (e.g., a ceramic combustion surface or metal combustion surface) with a plurality of ports for permitting a gas/air mixture to permeate through the combustion surface, wherein an area of the plurality of the ports is blocked or plugged to prevent the gas/air mixture from permeating through the combustion surface in the area.

The present invention also provides a household cooking appliance including a housing having an oven cavity, a broil burner in the oven cavity, the broil burner including a combustion surface (e.g., a ceramic combustion surface) with a plurality of ports for permitting a gas/air mixture to permeate through the combustion surface, wherein an area of the plurality of the ports is blocked or plugged to prevent the gas/air mixture from permeating through the combustion surface in the area.

The present invention further provides a household cooking appliance including a housing having an oven cavity, a broil burner in the oven cavity, the broil burner including a plenum, a combustion surface on the plenum, the combustion surface having a plurality of ports for permitting a gas/air mixture to permeate through the combustion surface, a venturi tube for supplying the gas/air mixture to the plenum, and an igniter for igniting the gas/air mixture, wherein the combustion surface includes a first area having a plurality of first ports for permitting the gas/air mixture to permeate through the combustion surface in the first area, a second area having a plurality of second ports for permitting the gas/air mixture to permeate through the combustion surface in the second area, and a third area having blocked or plugged ports, or formed without ports, for preventing the gas/air mixture from permeating through the combustion surface in the third area, the third area at least partially separating the first area from the second area to simulate a two burner broil burner system using a single broil burner and/or reduce a temperature at one or more predetermined hot spots on the combustion surface.

In this way, a single broil burner according to the present invention can be configured to perform as if the broil burner was formed by two separate burners, instead of a single burner, thereby enabling the exemplary broil burner to more evenly disperse the heat from a single burner and providing improved performance ordinarily associated with a two broil burner system using only a single burner system while providing the reduced cost, reduction in components, and reduction in space associated with a large single broil burner system.

Prior to describing the exemplary embodiments in greater detail, and to provide a better understanding of the invention, this disclosure will first describe some of the problems with conventional broiler units and broil burners for household cooking appliances.

As explained above, conventional household cooking appliances may include one or more different types of broil burners. For example, an appliance commonly may include two smaller broil burners that are side by side but have a space separating them, while another appliance may include a single, large broil burner that covers a majority of the top of the oven cavity. A broil burner arrangement that includes two separate small broil burners commonly performs better as a result of the separation between the broil burners, as compared to an arrangement with a single broil burner design. However, a broil burner arrangement with two separate broil burners can be more costly to manufacture and require additional components and space in the appliance. Particularly, a broil burner arrangement having two separate broil burners may have multiple ceramic combustion surfaces, plenums, venturi tubes/flues, and/or hot surface igniters, which can be costly to manufacture and can consume a large amount of space in the appliance.

The present invention provides a single type of broil burner that performs like two individual broil burners that are separated from each other without the drawbacks of a two burner system. More particularly, an exemplary embodiment provides a single, large broil burner, for example that covers a majority of the top of the oven cavity, in which a center or middle area of the broil burner is plugged with a material such that the single broil burner operates as if it was constructed by two separated burners. In this way, the present invention can disperse heat evenly throughout the oven cavity when using the broil function, thereby providing the improved performance associated with a two broil burner system while providing the reduced cost, reduction in components, and reduction in space associated with a large single broil burner system. Additionally, the present invention can provide greater flexibility in designing or fine tuning the disbursement of heat throughout the oven cavity for different models, designs, and arrangements of oven cavities, for example, on a case by case basis, as compared to a two burner system or multiple burner system.

In an exemplary embodiment, an oven cavity of a household cooking appliance includes a broil burner having a combustion surface (e.g., a ceramic combustion surface, a metal combustion surface, etc.) supported by a frame. The combustion surface includes a plurality of ports extending there through. The combustion surface and a frame are coupled to a plenum, which is supplied with a gas/air mixture by a single venturi tube and orifice. In another embodiment, the combustion surface can be coupled directly to the plenum without a frame. In operation, the single venturi tube feeds the gas/air mixture to the plenum of the broil burner, where the gas/air mixture permeates the plurality of ports of the combustion surface. A single hot surface igniter is provided to ignite the gas/air mixture permeating the combustion surface to heat the oven cavity.

By blocking or plugging a plurality of the ports in the middle or center portion of the combustion surface (e.g., a ceramic combustion surface) during manufacturing, the broil burner can be configured to perform as if it was formed by two separate burners arranged side by side, instead of a single burner. In this way, the exemplary broil burner can more evenly disperse the heat from a single burner and improve the performance of the single burner. Moreover, instead of two broil burners having multiple combustion surfaces, plenums, venturi tubes/flues, and hot surface igniters, the exemplary broil burner according the present invention can provide the performance of a two burner system with a single combustion surface (e.g., a single ceramic combustion surface), a single plenum, a single igniter, and a single venturi tube supplying the air/gas mixture to plenum, thereby providing a more cost effective broil burner while providing a more efficient system.

In an exemplary embodiment, an entire middle or center area of the ports of the combustion surface, for example from edge to edge along a midpoint of the combustion surface, can be blocked or plugged to prevent the gas/air mixture from permeating through this area of the combustion surface, thereby operationally dividing the single combustion surface into two separate regions to simulate a two burner system. The size and shape of the blocked or plugged area of the combustion surface is not limited to any particular size and shape.

The ports of the combustion surface (e.g., a ceramic combustion surface) can be blocked or plugged in any suitable manner that prevents the gas/air mixture from permeating through this area of the combustion surface. For example, the ports can be blocked or plugged (e.g., permanently blocked or plugged) by a continuous coating over the surface of the combustion surface that is to be blocked or plugged. In another example, the ports can be blocked or plugged (e.g., permanently blocked or plugged) by a material (e.g., a heat and/or flame resistant material) drawn into the ports of the combustion surface in the area that is to be blocked or plugged. In another example, the ports can be blocked or plugged (e.g., permanently blocked or plugged) by a plate (e.g., a fixed plate) covering the ports of the combustion surface in the area that is to be blocked or plugged. The ports can be blocked or plugged (e.g., permanently blocked or plugged) using a combination of one or more of these examples, or alternatively, using other suitable methods of blocking the ports. For example, in another embodiment, the combustion surface (e.g., ceramic or metal combustion surface) can be formed with a first area having a plurality of first ports and a second area having a plurality of second ports by omitting a forming process (e.g., a punching process) for a third area of the combustion surface during the manufacturing process to separate the plurality of first ports of the first area from the plurality of second ports of the second area to provide the performance of a two burner system with a single combustion surface (e.g., a single ceramic combustion surface), a single plenum, a single igniter, and a single venturi tube supplying the air/gas mixture to plenum, thereby providing a more cost effective broil burner while providing a more efficient system.

In another exemplary embodiment, one or more areas of the combustion surface (e.g., a ceramic combustion surface) can be blocked or plugged (e.g., permanently blocked or plugged) to fine tune the disbursement of heat throughout the oven cavity. More particularly, one or more areas of the combustion surface can be blocked or plugged to compensate for one or more predetermined hot spots that may occur in a particular arrangement of an oven cavity, such as a particular model of oven, thereby enabling the manufacturer to fine tune the disbursement of heat throughout the oven cavity for different models, designs, and arrangements of oven cavities, for example, on a case by case basis. Additionally or alternatively, one or more areas of the combustion surface can be blocked or plugged, for example by a service technician in the field, to compensate for one or more hot spots that may occur in a particular arrangement of a broil burner or oven cavity, such as a particular model of oven, thereby enabling the broil burner to be serviced to address specific issues with the actual performance of a particular broil burner to improve the disbursement of heat throughout the oven cavity or to compensate for one or more detected hot spots associated with that particular model, design, and/or arrangement of broil burner. For purposes of this disclosure, a hot spot is an area or plurality of areas of the combustion surface having a temperature that is greater than a temperature of adjacent or surrounding areas of the combustion surface, which may lead to uneven heating of the oven cavity across the combustion surface.

In another exemplary embodiment, one or more areas of the combustion surface (e.g., a ceramic combustion surface) can be blocked or plugged to provide a variety of different patterns of heat. For example, a broil burner can be configured to provide a striped pattern of areas for dispersing heat through the combustion surface. In other examples, a broil burner can be configured to provide a plurality of regions or zones for dispersing heat through the combustion surface of the broil burner. The broil burner is not limited to providing two zones or regions of heat, and can include any number of zones or regions of heat depending on the particular oven and its components, and desired performance of the broil burner system.

The size and shape of the blocked or plugged areas of the combustion surface are not limited to any particular size and shape, and can be the same size and shape or one or more different sizes, shapes, and/or patterns.

Other features and advantages of the present invention will become apparent to those skilled in the art upon review of the following detailed description and drawings.

### BRIEF DESCRIPTION OF THE DRAWINGS

These and other aspects and features of embodiments of the present invention will be better understood after a reading of the following detailed description, together with the attached drawings, wherein:

FIG. 1 is a front view of a household cooking appliance according to an exemplary embodiment of the invention.

FIG. 2 is a front view of a household cooking appliance with a door removed to show an oven cavity according to an exemplary embodiment of the invention.

FIG. 3 is a perspective view of a broil burner according to an exemplary embodiment of the invention.

FIG. 4 is a side view of the broil burner according to an exemplary embodiment of the invention shown in FIG. 3.

FIG. 5 is a bottom view of the broil burner according to an exemplary embodiment of the invention shown in FIG. 3.

FIG. 6 is a bottom view of a broil burner according to an exemplary embodiment of the invention.

FIG. 7 is a bottom view of a broil burner according to an exemplary embodiment of the invention.

FIG. 8 is a bottom view of a broil burner according to an exemplary embodiment of the invention.

FIG. 9 is a partial cutaway view of a ceramic combustion surface of a broil burner according to an exemplary embodiment of the invention.

FIG. 10 is a partial cutaway view of a ceramic combustion surface of a broil burner according to another exemplary embodiment of the invention.

### DETAILED DESCRIPTION OF THE EXEMPLARY EMBODIMENTS OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Referring now to the drawings, FIGS. 1-10 illustrate exemplary embodiments of a broil burner having a combustion surface (e.g., a ceramic combustion surface, metal combustion surface, etc.) with a plurality of ports being blocked or plugged such that the broil burner is configured to perform as if it was formed by two separate burners, instead of a single burner, thereby enabling the exemplary broil burner to more evenly disperse the heat from a single burner and providing improved performance ordinarily associated with a two broil burner system using only a single burner system while providing the reduced cost, reduction in components, and reduction in space associated with a large single broil burner system.

Examples of a household cooking appliance and broil burner will first be described with reference to FIGS. 1 and 2.

FIG. 1 illustrates an example of a household cooking appliance 100. In the example appliance of FIG. 1, the household cooking appliance 100 includes one or more of an oven 102 (e.g., baking oven or convection oven), a steam oven 104, and a warming drawer 106. The household cooking appliance 100 can include a control panel 112 having one or more control devices 114, such as control knobs, for controlling one or more components or modules of the appliance, such as the oven 102, steam oven 104, or a broil burner (not shown in FIG. 1) in the oven 102 or oven 104. Other arrangements and features are possible, such as a single oven range, a cooktop, a wall oven, among other arrangements. The appliance 100 can be a stand-alone appliance, a built-in appliance, a counter-top appliance, or in-counter appliance.

A household cooking appliance 100 ordinarily can include one or more gas burners 108 or induction heating elements (not shown), and/or one or more cooktop cooking modules 110, such as one or more of a griddle, a grill, an induction heating element, a teppanyaki grill, a rotisserie, or the like, as well as various accessories to such cooking devices. FIGS. 1-3 show examples of household cooking appliances 100 having a single cooking module 110 in combination with one or more gas burners 108. However, in other embodiments, the appliance 100 can include one or more modules arranged in the appliance. The number of modules is not limited to any particular number and can include any number of modules based on the size of the appliance 100 and the size and shape of the respective modules 110. In other embodiments, the appliance 100 can be formed entirely from a plurality of modules 110 and without providing gas burners 108. In other embodiments, the appliance can include one or more ovens (e.g., 102, 104) without a cooktop having burners 108 or modules 110 and/or without a warming drawer 106.

With reference to an example appliance 100 illustrated in FIG. 2 without an oven door for clarity, the appliance 100 can include a housing 116 having an oven cavity 118. A control panel 112 can be provided with one or more control knobs 114 for controlling one or more cooking devices on the appliance. The oven cavity 118 can include a broil burner 120 for cooking food that is placed inside the oven cavity 118, for example on one or more shelves 119. The broil burner 120 can be positioned at the top of the oven cavity 118 as shown. More particularly, the oven cavity 118 includes a single, large broil burner 120, for example that covers all or a majority of the top of the oven cavity 118. However, in other embodiments, the broil burner 120 can be disposed at other locations, such as in a bottom of the oven cavity for providing a variety of types of cooking functions and methods. The oven cavity 118 also can include a broil burner 120 or infrared burner at a top and bottom of the oven cavity 118. FIG. 2 is a simplified schematic illustration of an appliance 100 and can include other components or elements not shown in FIG. 2, such as one or more baking elements (e.g., one or more of an electric baking element, steam cooking device, gas burner device, convection fan, etc.), shelves or racks, shelf or rack supports, etc.

With reference to FIGS. 3-9, several exemplary embodiments of a broil burner 120 will now be described.

As shown in FIGS. 3-5, an exemplary broil burner 120 includes a combustion surface 122 supported by a frame 124. The combustion surface 122 can include a ceramic combustion surface, a metal combustion surface such as stainless steel, or the like. The combustion surface 122 and a frame 124 are coupled to a plenum 126, which can be supplied with a gas/air mixture by a single venturi tube 128 and orifice 130. Other arrangements for supplying the plenum 126 with the gas/air mixture can be provided. In other embodiments, the combustion surface 122 can be coupled directly to the plenum 126 without a frame 124. The combustion surface 122 includes a plurality of ports 121, for example as shown in the enlargement of FIG. 3, that permit the gas/air mixture to permeate the combustion surface 122 from the interior of the plenum 126 to the side of the broil burner 120 facing the oven cavity 118 (e.g., the lower side shown in FIG. 4). A hot surface, spark, or pilot igniter (not shown) is provided to ignite the gas/air mixture permeating the combustion surface 122 to heat the oven cavity 118.

In the example combustion surface 122 (e.g., a ceramic combustion surface) illustrated in FIGS. 3 and 5, a plurality of the burner ports 121 in the middle or center portion 132 of the combustion surface 122 is blocked or plugged (e.g., permanently blocked or plugged) to prevent the gas/air mixture from permeating through these ports. The burner ports 121 in the other regions 134 are not blocked or plugged, and therefore, permit the gas/air mixture to permeate through these ports to heat the oven cavity. As shown in the example in FIGS. 3 and 5, the blocked or plugged region 132 divides the unblocked region 134 into two parts or sub-regions. In operation, the single venturi tube 128 feeds the gas/air mixture to the plenum 126 of the broil burner 120, where the gas/air mixture permeates the plurality of ports 121 in the regions 134 of the combustion surface 122, which are entirely or partly separated by one or more blocked or plugged regions 132, thereby enabling the broil burner 120 to perform as if it was formed by two separate burners arranged side by side, instead of a single burner. In this way, the exemplary broil burner can more evenly disperse the heat from a single burner and improve the performance of the single burner. Moreover, instead of two broil burners having multiple combustion surfaces (e.g., ceramic combustion surfaces), plenums, venturi tubes/flues, and hot surface igniters, the exemplary broil burner according the present invention can provide the performance of a two burner system with a single combustion surface (e.g., a ceramic combustion surface) 122, a single plenum 126, and a single venturi tube 128 supplying the air/gas mixture to plenum 126, thereby providing a more cost effective broil burner while providing a more efficient system.

With reference to FIGS. 5-10, several examples of arrangements of a broil burner 120 having a combustion surface (e.g., a ceramic combustion surface) 122 with the blocked or plugged regions 132 will now be described.

As shown in the examples of FIGS. 5 and 6, a portion or an entire middle or center area or region 132 of the ports 121 of the combustion surface 122, for example from edge to edge along a midpoint of the combustion surface 122 as shown in FIG. 6, can be blocked or plugged to prevent the gas/air mixture from permeating through this area or region 132 of the combustion surface 122, thereby operationally dividing the single combustion surface 122 into two separate regions 134 to simulate a two burner system. The size and shape of the blocked or plugged area or region(s) 132 of the combustion surface 122 is not limited to any particular size and shape. Similarly, the size and shape of the unblocked or unplugged area or region(s) 134 of the combustion surface 122 is not limited to any particular size and shape.

In another exemplary embodiment, one or more areas 136 of the combustion surface (e.g., a ceramic combustion surface) 122 additionally or alternatively can be blocked or plugged to fine tune the disbursement of heat throughout from the broil burner 120 into the oven cavity. More particularly, one or more areas 136 of the combustion surface 122 can be blocked or plugged at locations of one or more predetermined hot spots that may occur on the broil burner for a particular arrangement of an oven cavity, such as a particular model of oven, thereby enabling the manufacturer to minimize or avoid such hot spots and fine tune the disbursement of heat throughout the oven cavity for different models, designs, and arrangements of oven cavities, for example, on a case by case basis. The number, size, and shape of the blocked or plugged area or region(s) 136, which correspond to hot spots of the ceramic combustion surface 122, are not limited to any particular arrangement and can be universally provided for a particular model, design, or arrangement of oven cavity, or customized on a case by case basis for individual oven cavities based on testing and/or quality control measures, for example, as shown in the examples illustrated in FIGS. 5-8.

In other exemplary embodiments, one or more areas 132 of the combustion surface (e.g., a ceramic combustion surface) 122 can be blocked or plugged to provide a variety of different patterns of unblocked or unplugged areas 134 for disbursing heat across the broil burner 120. For example, as shown in the exemplary embodiment illustrated in FIG. 7, a broil burner 120 can be configured to provide a combustion surface 122 having a striped pattern of areas 134 for dispersing heat through the combustion surface 122. In other embodiments, as shown in the exemplary embodiment illustrated in FIG. 8, a broil burner 120 can be configured to provide a combustion surface 122 having a plurality of regions or zones 134 for dispersing heat through the combustion surface 122 of the broil burner 120. The broil burner 120 of the present invention is not limited to providing two zones or regions of heat, and can include any number of zones or regions of heat depending on the particular oven and its components, and desired performance of the broil burner system. The blocked/plugged areas 132 or unblocked/unplugged areas 134 of the combustion surface 122 are not limited to any particular number, size, or shape. One or more of the blocked/plugged areas 132 and/or unblocked/unplugged areas 134 can have the same size and/or shape, or one or more different sizes, shapes, and/or patterns, or the areas 132 and/or 134 can be randomly distributed based on the particular appliance.

As shown in FIGS. 9 and 10, the ports 121 of the combustion surface (e.g., a ceramic combustion surface) 121 can be blocked or plugged in any suitable manner that prevents the gas/air mixture from permeating through this area of the combustion surface 122. For example, as shown in FIG. 9, the ports 121 can be blocked by a continuous coating or a plate 142 (e.g., over the area or region 132 of the surface of the combustion surface 122 that is to be blocked without affecting the areas 134 that are to remain unblocked. In another example, as shown in FIG. 10, the ports 121 can be plugged by a material 152 (e.g., a heat and/or flame resistant material), for example, injected into or drawn into the ports 121 of the combustion surface 122 in the area that is to be plugged. The ports 121 can be blocked or plugged using a combination of one or more of these examples, or alternatively, using other suitable methods of blocking the ports 121.

In another embodiment, the combustion surface (e.g., a ceramic combustion surface) 122 can be formed such that the plurality of ports are interposed by, or divided by, one or more predetermined areas that do not include any ports. For example, as explained above, the area of the plurality of the ports that is blocked or plugged can be formed by manufacturing the combustion surface without any ports in that area. More particularly, with reference again to FIGS. 2, 3, and 5, a household cooking appliance 100 according to another exemplary embodiment can include a housing 116 having an oven cavity 118, a broil burner 120 in the oven cavity 118 (as shown for example in FIG. 2), the broil burner 118 including a plenum 126, a combustion surface 122 on the plenum 126, the combustion surface 122 having a plurality of ports 121 for permitting a gas/air mixture to permeate through the combustion surface 122, a venturi tube 128 for supplying the gas/air mixture to the plenum 126, and an igniter (not shown) for igniting the gas/air mixture (as shown for example in FIG. 3). In this example, the combustion surface 122 can include a first area (e.g., part of area 134 on the left-hand side in FIG. 5) having a plurality of first ports 121 for permitting the gas/air mixture to permeate through the combustion surface 122 in the first area, a second area (e.g., part of area 134 on the right-hand side in FIG. 5) having a plurality of second ports 121 for permitting the gas/air mixture to permeate through the combustion surface in the second area, and a third area (e.g., 132, 136) having blocked or plugged ports and/or formed without ports for preventing the gas/air mixture from permeating through the combustion surface 122 in the third area (e.g., 132, 136). The third area (e.g., 132, 136) can at least partially separate the first area from the second area to simulate a two burner broil burner system using the broil burner and/or reduce a temperature at one or more predetermined hot spots (e.g., at 136) on the combustion surface.

The present invention has been described herein in terms of several preferred embodiments. However, modifications and additions to these embodiments will become apparent to those of ordinary skill in the art upon a reading of the foregoing description. It is intended that all such modifications and additions comprise a part of the present invention to the extent that they fall within the scope of the several claims appended hereto.

1-28. (canceled)

29. A household cooking appliance comprising:
a housing; and
a burner on the housing, the burner including:
a combustion surface with a plurality of ports for permitting a gas/air mixture to permeate through the combustion surface,
wherein an area of the plurality of ports is blocked or plugged to prevent the gas/air mixture from permeating through the combustion surface in the area.

30. The household cooking appliance of claim 29, wherein the burner further comprises:
a plenum; and
a frame supporting the combustion surface on the plenum.

31. The household cooking appliance of claim 30, wherein the burner further comprises:
a venturi tube for supplying the gas/air mixture to the plenum.

32. The household cooking appliance of claim 29, wherein the area of the plurality of ports that is blocked or plugged is in one of a middle portion and a center portion of the combustion surface to at least partially divide the plurality of ports into a first region of unblocked ports and a second region of unblocked ports that permit the gas/air mixture to permeate through the combustion surface.

33. The household cooking appliance of claim 32, wherein the area of the plurality of ports that is blocked or plugged extends from edge to edge of the combustion surface across the one of the middle portion and the center portion of the combustion surface.

34. The household cooking appliance of claim 29, wherein the area of the plurality of ports that is blocked or plugged forms a striped pattern on the combustion surface to at least partially divide the plurality of ports into a plurality of regions of unblocked ports that permit the gas/air mixture to permeate through the combustion surface.

35. The household cooking appliance of claim 29, wherein the area of the plurality of ports that is blocked or plugged forms a pattern of shapes on the combustion surface to at least partially divide the plurality of ports into a plurality of regions of unblocked ports that permit the gas/air mixture to permeate through the combustion surface.

36. The household cooking appliance of claim 29, wherein the area of the plurality of ports that is blocked or plugged on the combustion surface corresponds to one or more predetermined hot spots on the combustion surface.

37. The household cooking appliance of claim 32, wherein the area of the plurality of ports that is blocked or plugged further comprises a second area on the combustion surface that corresponds to one or more predetermined hot spots on the combustion surface.

38. The household cooking appliance of claim 29, further comprising:
a coating on the area of the combustion surface that prevents the gas/air mixture from permeating through the combustion surface in the area.

39. The household cooking appliance of claim 29, further comprising:
a plate on the area of the combustion surface that prevents the gas/air mixture from permeating through the combustion surface in the area.

40. The household cooking appliance of claim 29, further comprising:
a material injected into or drawn into the ports of the area of the combustion surface to prevent the gas/air mixture from permeating through the combustion surface in the area.

41. The household cooking appliance of claim 29, wherein the area of the plurality of ports that is blocked or plugged is formed by manufacturing the combustion surface without ports in the area.

42. The household cooking appliance of claim 29, wherein the burner is positioned at a top of the oven cavity and extends across all or a majority of a width of the top of the oven cavity.

43. A household cooking appliance comprising:
a housing having at least one burner, the at least one burner including:
a plenum;
a combustion surface on the plenum, the combustion surface having a plurality of ports for permitting a gas/air mixture to permeate through the combustion surface;
a venturi tube for supplying the gas/air mixture to the plenum; and
an igniter for igniting the gas/air mixture,
wherein the combustion surface includes:
a first area having a plurality of first ports for permitting the gas/air mixture to permeate through the combustion surface in the first area;
a second area having a plurality of second ports for permitting the gas/air mixture to permeate through the combustion surface in the second area; and
a third area having at least one of blocked or plugged ports and an area formed without ports for preventing the gas/air mixture from permeating through the combustion surface in the third area, the third area at least partially separating the first area from the second area for at least one of simulating a two burner system using the burner and reducing a temperature at one or more predetermined hot spots on the combustion surface.

44. A burner for a household cooking appliance, the burner comprising:
a combustion surface with a plurality of ports for permitting a gas/air mixture to permeate through the combustion surface,
wherein an area of the plurality of ports is blocked or plugged to prevent the gas/air mixture from permeating through the combustion surface in the area.

45. The burner of claim 44, further comprising:
a plenum; and
a frame supporting the combustion surface on the plenum.

46. The burner of claim 45, further comprising:
a venturi tube for supplying the gas/air mixture to the plenum.

47. The burner of claim 44, wherein the area of the plurality of ports that is blocked or plugged is in one of a middle portion and a center portion of the combustion surface and at least partially divides the plurality of ports into a first region of unblocked ports and a second region of unblocked ports that permit the gas/air mixture to permeate through the combustion surface.

48. The burner of claim 47, wherein the area of the plurality of ports that is blocked or plugged extends from edge to edge of the combustion surface across the one of the middle portion and the center portion of the combustion surface.

49. The burner of claim 44, wherein the area of the plurality of ports that is blocked or plugged forms a striped pattern on the combustion surface and at least partially divides the plurality of ports into a plurality of regions of unblocked ports that permit the gas/air mixture to permeate through the combustion surface.

50. The burner of claim 44, wherein the area of the plurality of ports that is blocked or plugged forms a pattern of shapes on the combustion surface and at least partially divides the plurality of ports into a plurality of regions of unblocked ports that permit the gas/air mixture to permeate through the combustion surface.

51. The burner of claim 44, wherein the area of the plurality of ports that is blocked or plugged on the combustion surface corresponds to one or more predetermined hot spots on the combustion surface.

52. The burner of claim 47, wherein the area of the plurality of ports that is blocked or plugged further comprises a second area on the combustion surface that corresponds to one or more predetermined hot spots on the combustion surface.

53. The burner of claim 44, further comprising:
a coating on the area of the combustion surface that prevents the gas/air mixture from permeating through the combustion surface in the area.

54. The burner of claim 44, further comprising:
a plate on the area of the combustion surface that prevents the gas/air mixture from permeating through the combustion surface in the area.

55. The burner of claim 44, further comprising:
a material injected into or drawn into the ports of the area of the combustion surface to prevent the gas/air mixture from permeating through the combustion surface in the area.

56. The burner of claim 44, wherein the area of the plurality of ports that is blocked or plugged is formed by manufacturing the combustion surface without ports in the area.

57. A household cooking appliance comprising:
a combustion surface with a plurality of ports for permitting a gas/air mixture to permeate through the combustion surface,
wherein an area of the plurality of ports is blocked or plugged to prevent the gas/air mixture from permeating through the combustion surface in the area.
